(19) United States
(12) Patent Application Publication
(10) Pub. No.: US 2023/0304251 A1
(43) Pub. Date: Sep. 28, 2023

(54) LOCKING APPARATUS FOR MANHOLE IRON COVER

(71) Applicant: NIPPON CHUTETSUKAN K.K., Tokyo (JP)

(72) Inventor: Nobuyuki HATA, Kuki-Shi, Saitama (JP)

(73) Assignee: NIPPON CHUTETSUKAN K.K., Tokyo (JP)

(21) Appl. No.: 18/002,583

(22) PCT Filed: Dec. 14, 2020
(86) PCT No.: PCT/JP2020/046466

§ 371 Date: Dec. 20, 2022

(30) Foreign Application Priority Data
Jul. 8, 2020 (JP) 2020-117809

(51) Int. Cl. E02D 29/14

(52) U.S. Cl. CPC E02D 29/1427; E02D 29/1445

(57) ABSTRACT

A manhole cover locking apparatus that can promptly release the pressure in a sewerage pipe, suppress the lifting height of the cover, and stabilize the cover when lifted by pressure, including a lock main body, a hook, an engagement part that engages a claw for opening the cover; and a hook receiver on a receiving frame. The lock main body is attached rotabably about a pivotal support, and has a pressing part on a peripheral side of the cover with respect to the pivotal support part. A claw abutment surface that abuts against the claw is formed on an upper surface of the pressing part. When the hook and the hook receiver engage with each other, the claw abutment surface and an upper surface of the receiving frame are located at substantially the same height.

### TECHNICAL FIELD

The present invention relates to a locking apparatus for a manhole iron cover that can prevent a pressure rise in a sewerage pipe by lifting the cover.

### BACKGROUND ART

A manhole iron cover fulfills a role of, for example: blocking a ground surface opening part of a hole that is provided to a road or the like in order to check and manage piping of sewerage; and thus preventing falling of pedestrians and obstruction to traffic of cars, two-wheel vehicles, and the like. In addition, for the case when the pressure in a sewerage pipe rises due to torrential rain or the like, provided is a function of releasing the pressure by lifting the cover.

Moreover, a locking apparatus for the manhole iron cover is provided with a function of: holding the cover such that the cover does not succumb to the pressure and is not blown off, even when the cover is lifted as described above; and preventing an unspecified person from easily opening the cover.

A locking apparatus for a manhole iron cover according to Patent Literature 1 has a structure in which: the cover is provided with a hook; a receiving frame is provided with a hook receiver; and the hook and the hook receiver engage with each other when the cover is lifted, whereby blow-off of the cover is prevented. Moreover, at normal times, the cover is locked while being fitted in the receiving frame. At this time, a pressing part for unlocking the cover is placed at a position at which the pressing part is invisible from the outside. Hence, opening of the cover by an unspecified person can be prevented.

### CITATION LIST

### Patent Literature

Patent Literature 1: Japanese Patent No. 2992230

### SUMMARY OF INVENTION

### Technical Problem

In general, considering the case when the pressure in a sewerage pipe is released by lifting a manhole iron cover, if the lifting height of the cover is large, it is advantageous in terms of promptly releasing the pressure in the pipe in order to protect the sewerage pipe. On the other hand, a large step occurs on a road, and may become an obstacle when pedestrians, cars, and the like pass over the manhole. Moreover, as a result of the revision of “JIS A 5506 Manhole covers for sewerage works” in recent years, described is the standard that the lifting height of a cover for releasing the pressure in a manhole should be equal to or less than 20 mm, and hence it becomes necessary to comply with this standard.

In view of this, the present invention has been made under the above-mentioned circumstances, and has an object to provide a locking apparatus for a manhole iron cover that can promptly release the pressure in a sewerage pipe, can suppress the lifting height of the cover, and can make the posture of the lifted cover stable, when the cover is lifted due to a pressure rise in the pipe.

### Solution to Problem

This invention has been made in order to achieve the above-mentioned object, and has the following features.

A locking apparatus for a manhole iron cover according to the present invention is a locking apparatus for a manhole iron cover, for locking a cover fitted in a receiving frame, including: a lock main body that is attached to a peripheral lower surface of the cover and includes at least one hook; a recessed part that is formed on an upper surface of the cover and includes an engagement part that engages with a claw for opening the cover; and a hook receiver that is formed in a peripheral wall lower part of the receiving frame and engages with the hook, in which the lock main body includes: a pivotal support part having an axis that is parallel to a lower surface of the cover; and a pressing part on a peripheral side of the cover with respect to the pivotal support part, a claw abutment surface that abuts against the claw is formed on an upper surface of the pressing part, an inclined part is formed on the lower surface of the cover, the lower surface being opposed to the claw abutment surface, when the hook and the hook receiver engage with each other, the claw abutment surface and an upper surface of the receiving frame are located at substantially a same height, and the lock main body itself is attached rotatably about the pivotal support part.

In the locking apparatus for the manhole iron cover according to the present invention, the lock main body includes at least one receiving frame abutment part below the pivotal support part, the receiving frame abutment part being abuttable against a peripheral wall upper part of the receiving frame, and a clearance part for avoiding contact with the peripheral wall upper part of the receiving frame is formed in a lower part of the hook.

In the locking apparatus for the manhole iron cover according to the present invention, an engagement part between the hook and the hook receiver is provided on each of left and right sides with respect to a center of the lock main body.

In the locking apparatus for the manhole iron cover according to the present invention, the hook is formed below the pivotal support part and on the peripheral side of the cover with respect to the pivotal support part.

In the locking apparatus for the manhole iron cover according to the present invention, the receiving frame abutment part is formed in substantially the center of the lock main body.

In the locking apparatus for the manhole iron cover according to the present invention, the receiving frame abutment part is formed on each of left and right sides with respect to the center of the lock main body.

In the locking apparatus for the manhole iron cover according to the present invention, a width of an opening part that is formed in a peripheral wall of the cover and is continuous with the inclined part is larger than a width of the pressing part, and a gap in a circumferential direction of the cover exists between the opening part and the pressing part.

In the above-mentioned summary of the invention, features necessary for the present invention are not entirely listed, and subcombinations of these feature groups can also be included in the invention.

### Advantageous Effects of Invention

According to the present invention, when the cover is lifted due to a pressure rise in a sewerage pipe, the pressure in the pipe can be promptly released, the lifting height of the cover can be suppressed to be equal to or less than the above-mentioned standard (20 mm), and the posture of the lifted cover can be made stable.

Moreover, according to the present invention, at a cover closed time of the cover, the receiving frame abutment part and the peripheral wall upper part of the receiving frame are caused to abut against each other, and contact between the hook and the receiving frame is avoided, whereby damage to the hook can be prevented.

### BRIEF DESCRIPTION OF DRAWINGS

FIG. 1 is a cross-sectional view at the time of locking of a locking apparatus for a manhole iron cover according to the present embodiment.

FIG. 2 is a cross-sectional view illustrating a state where the cover according to the present embodiment is elevated by a claw.

FIG. 3 is a cross-sectional view illustrating a state where the cover is unlocked by rotating a lock main body according to the present embodiment by a fixed hook of the claw.

FIG. 4 is a cross-sectional view illustrating a state at a cover closed time of the cover according to the present embodiment.

FIG. 5 is a perspective view illustrating the locking apparatus for the manhole iron cover according to the present embodiment.

FIG. 6 is a front view of the locking apparatus for the manhole iron cover according to the present embodiment.

### DESCRIPTION OF EMBODIMENT

Hereinafter, a preferred embodiment for carrying out the present invention is described with reference to the drawings. Note that the following embodiment does not limit the invention according to each claim, and all combinations of features described in the embodiment are not necessarily essential to solutions provided by the invention.

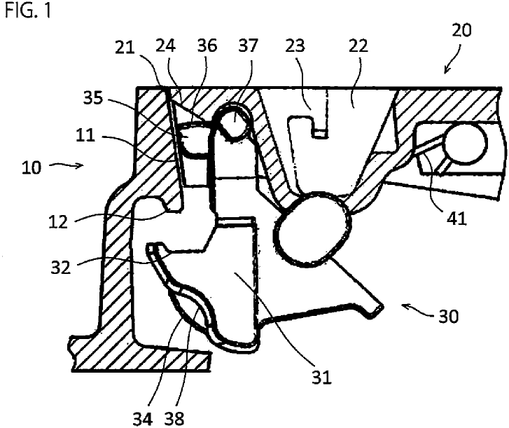

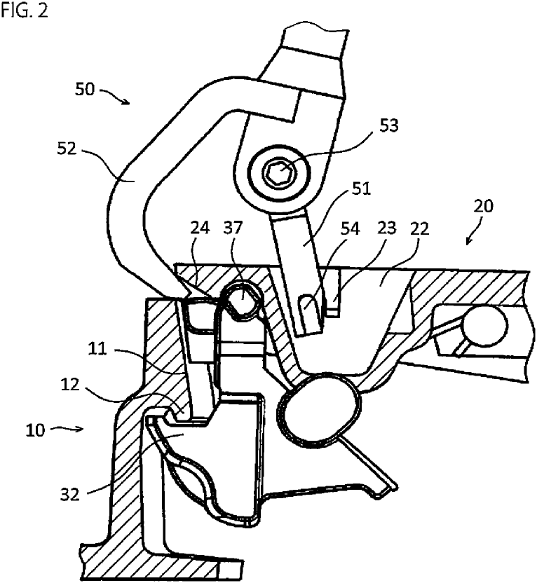

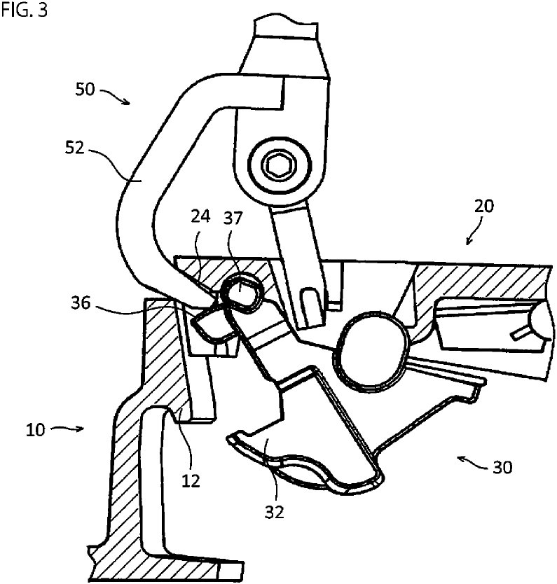

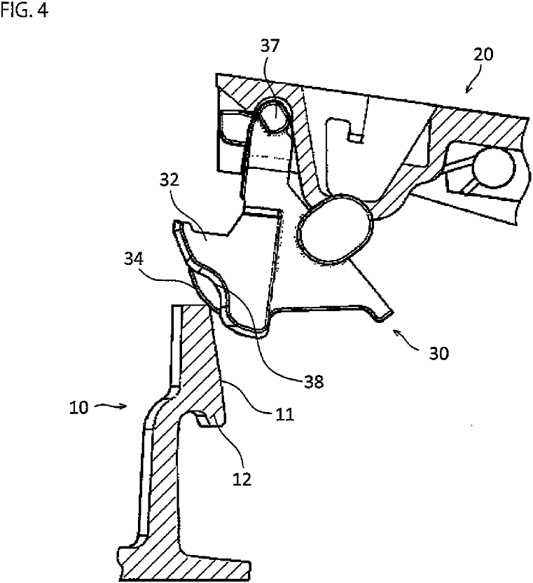

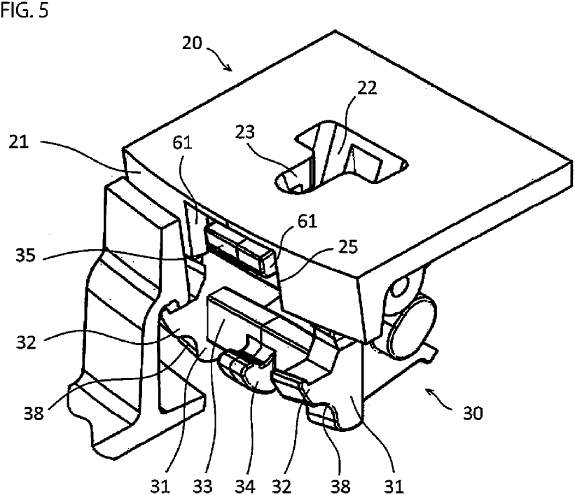

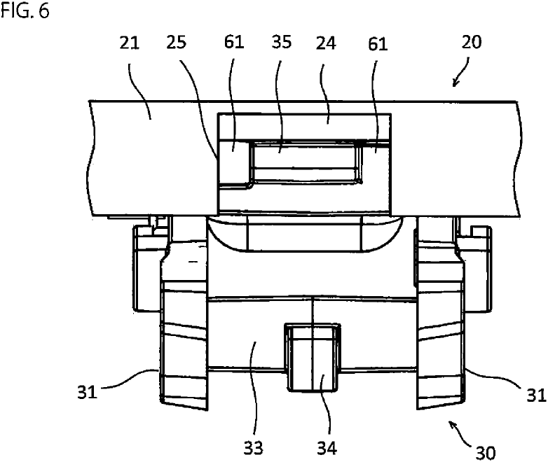

FIG. 1 is a cross-sectional view at the time of locking of a locking apparatus for a manhole iron cover according to the present embodiment. FIG. 2 is a cross-sectional view illustrating a state where the cover according to the present embodiment is elevated by a claw. FIG. 3 is a cross-sectional view illustrating a state where the cover is unlocked by rotating a lock main body according to the present embodiment by a fixed hook of the claw. FIG. 4 is a cross-sectional view illustrating a state at a cover closed time of the cover according to the present embodiment. FIG. 5 is a perspective view illustrating the locking apparatus for the manhole iron cover according to the present embodiment. FIG. 6 is a front view of the locking apparatus for the manhole iron cover according to the present embodiment.

As illustrated in FIG. 1, the locking apparatus for the manhole iron cover according to the present embodiment is configured by: a hook receiver 12 that is formed in a receiving frame 10 placed in an upper part of a manhole; a lock main body 30 that is attached to a lower part of a cover 20; and a recessed part 22 that is formed on an upper surface of the cover 20.

The receiving frame 10 is placed in the upper part of the manhole that has a circular opening and is provided to a road or the like in order to, for example, check and manage piping of sewerage. As illustrated in FIG. 1, a peripheral wall 11 of the receiving frame 10 has such a gradient that the diameter of the circle becomes smaller downward from the opening surface, and the peripheral wall 11 includes the hook receiver 12 at a lower end of the gradient, the hook receiver 12 engaging with hooks 32 to be described later. The hook receiver 12 includes a protrusion part that is extended downward from the peripheral wall 11 of the receiving frame 10 and is continuous in the circumferential direction. Moreover, a gradient similar to that of the peripheral wall 11 of the receiving frame 10 is applied to a peripheral wall 21 of the cover 20. Hence, when the cover 20 is fitted in the receiving frame 10, the peripheral wall 21 of the cover 20 and the peripheral wall 11 of the receiving frame 10 come in contact with each other, whereby such a structure that prevents the cover 20 from dropping is obtained.

As illustrated in FIG. 1 and FIG. 5, the lock main body 30 includes: a pivotal support part 37 that is an attachment part to the cover 20; a pressing part 35 that is formed on the peripheral side of the cover 20 with respect to the pivotal support part 37; side walls 31 that respectively extend downward from both ends of the pivotal support part 37; the hooks 32 that are formed below the pivotal support part 37 and on the peripheral side of the cover 20 with respect to the pivotal support part 37; a communication part 33 that allows the left and right side walls 31 to communicate with each other; and a receiving frame abutment part 34 that abuts against the peripheral wall 11 of the receiving frame 10 at a cover closed time of the cover 20.

The pivotal support part 37 is located on a peripheral lower surface of the cover 20 and allows the lock main body 30 to be attached rotatably about an axis that is parallel to a lower surface of the cover 20 and parallel to a tangent to the peripheral wall 21 of the cover 20.

The pressing part 35 is formed on the peripheral side of the cover 20 with respect to the pivotal support part 37. As illustrated in FIG. 1, an end part of the pressing part 35 is located on the inner side from the peripheral wall 21 of the cover 20 having the gradient. In the state where the cover 20 is locked, the end part of the pressing part 35 does not come in contact with the peripheral wall 11 of the receiving frame 10. Moreover, a flat surface is formed in an upper part of the pressing part 35, and the upper part of the pressing part 35 thus includes a claw abutment surface 36 that abuts against a claw 50 to be described later. Note that the height of the claw abutment surface 36 is preferably located at a height that is parallel to or higher than the center of the pivotal support part 37.

The side walls 31 are formed so as to respectively extend downward from both the end parts of the pivotal support part 37. The side walls 31 respectively include the hooks 32 on the peripheral side of the cover 20, and include a portion for attaching a torsion spring 41 to be described later on the central side of the cover 20. Assuming that the direction illustrated in FIG. 6 is the front side of the lock main body 30, the two side walls 31 respectively located on the left and right sides are bilaterally symmetric with respect to an imaginary central plane located in the center of these two side walls 31.

The hooks 32 are formed so as to be respectively continuous in plane with the side walls 31. Moreover, a clearance part 38 is formed in a lower part of each hook 32 so as not to come in contact with the receiving frame 10 at the cover closed time of the cover 20, and the clearance part 38 is configured by making part of each side wall 31 into a concave shape.

The communication part 33 is located below the pivotal support part 37, and allows the left and right side walls 31 to communicate with each other. Moreover, the receiving frame abutment part 34 is formed in substantially the center of the communication part 33, and abuts against an upper end of the peripheral wall 11 of the receiving frame 10 at the cover closed time of the cover 20 as illustrated in FIG. 4. Because the clearance parts 38 are respectively formed in the side walls 31 as described above, at the cover closed time of the cover 20, only the receiving frame abutment part 34 abuts against the receiving frame 10, and this prevents damage to portions other than the receiving frame abutment part 34, of the lock main body 30. In this way, at the cover closed time of the cover 20, the communication part 33 is subjected to external force from below via the receiving frame abutment part 34. Hence, a cross-sectional shape of the communication part 33 is preferably a shape that is resistant to bending due to such external force from below, and the cross-sectional shape of the communication part 33 is, for example, a substantially rectangular shape having its long sides in the top-bottom direction.

Moreover, in the state where external force is not applied, as illustrated in FIG. 1, the lock main body 30 is held about the pivotal support part 37 in a direction in which the hooks 32 engage with the hook receiver 12, by the own weight of the lock main body 30 and the torsion spring 41.

As illustrated in FIG. 1, the cover 20 includes: the peripheral wall 21 having the gradient as described above; and the recessed part 22 into which the claw 50 to be described later is inserted.

As illustrated in FIG. 5 and FIG. 6, an opening part 25 is formed in a portion of the peripheral wall 21 of the cover 20, and the pressing part 35 of the lock main body 30 is located in this portion. The width of the opening part 25 is larger than the width of the pressing part 35, and hence a gap 61 in the circumferential direction of the cover 20 is made between the opening part 25 and the pressing part 35.

An inclined part 24 is formed on an upper surface of the opening part 25, and is inclined downward from the peripheral wall 21 of the cover 20 toward the center of the cover 20. The inclined part 24 is opposed to the claw abutment surface 36 of the lock main body 30. As illustrated in FIG. 1, the inclined part 24 and the claw abutment surface 36 form a space that is substantially triangular in cross-section.

As illustrated in FIG. 1 and FIG. 5, the recessed part 22 includes a bag-like depression on the upper surface on the peripheral side of the cover 20. A portion of an opening part of the recessed part 22 on the central side of the cover 20 is shaped so as to be wider in the axial direction of the pivotal support part 37 of the lock main body 30, and a portion of the opening part thereof on the peripheral side of the cover 20 is shaped so as to be narrower than the portion of the opening part thereof on the central side, whereby the opening part thereof has a substantially T-shape when viewed from the upper surface side. Moreover, a claw engagement part 23 is provided below the narrower portion of the opening part of the recessed part 22. Although the lock main body 30 is located below the recessed part 22, because the lock main body 30 has a space between the left and right side walls 31, a lower surface of the bag-like recessed part 22 that protrudes from the lower surface of the cover 20 does not interfere with the lock main body 30.

In order to open the cover 20, the claw 50 having such a structure as illustrated in FIG. 2 is used. The claw 50 includes a rotating hook 51 and a fixed hook 52 at a leading end thereof. The rotating hook 51 includes a protrusion part 54 at a leading end thereof, and the protrusion part 54 protrudes on both the near and far sides on the sheet of FIG. 2. The rotating hook 51 rotates about a claw pivotal support part 53. The fixed hook 52 has such a hook shape as illustrated in FIG. 2, and is fixed to the claw pivotal support part 53.

Next, description is given of a method of opening and locking the cover 20 by the locking apparatus for the manhole iron cover according to the present embodiment.

First, the rotating hook 51 of the claw 50 is inserted in the recessed part 22 of the cover 20, and the protrusion part 54 is engaged with the claw engagement part 23. At this time, a leading end of the fixed hook 52 is brought into contact with an upper part of the peripheral wall 11 of the receiving frame 10.

Next, as illustrated in FIG. 2, the claw 50 is moved down toward the fixed hook 52. As a result, the cover 20 is elevated with the leading end of the fixed hook 52 serving as a fulcrum, and a gap is made between the upper part of the peripheral wall 11 of the receiving frame 10 and the inclined part 24. If the claw 50 is further moved down, as illustrated in FIG. 3, the fixed hook 52 comes in between the inclined part 24 and the claw abutment surface 36, and pushes the claw abutment surface 36 so as to widen a gap between the inclined part 24 and the claw abutment surface 36. The lock main body 30 whose claw abutment surface 36 has been pushed rotates about the pivotal support part 37, and the hooks 32 come off the hook receiver 12, whereby the cover 20 is unlocked. The unlocked cover 20 can be opened from the receiving frame 10 by further moving the claw 50 down.

At this time, the hooks 32 are formed below the pivotal support part 37 and on the peripheral wall 21 side of the cover 20 with respect to the pivotal support part 37. Hence, when the lock main body 30 rotates about the pivotal support part 37, the track of each of leading end parts of the hooks 32 starts from a position higher than a lowest point of an arc whose center is the pivotal support part 37, and the track thereof is drawn so as to pass through the lowest point of the arc. Therefore, even from the state where the hooks 32 engage with the hook receiver 12 as illustrated in FIG. 2, the unlocking can be performed such that the leading end parts of the hooks 32 escape from the protrusion part at a leading end of the hook receiver 12.

On the other hand, when the cover 20 is closed, it is preferable to adopt a procedure that is the reverse of that adopted at the time of opening the cover 20 as described above, that is, it is preferable to rotate the lock main body 30 using the claw 50 and close the cover 20. However, at an actual site of work, conceivable is the case where the cover 20 is dropped and directly fitted in the receiving frame 10 without using the claw 50. On this occasion, as illustrated in FIG. 4, the receiving frame abutment part 34 abuts against the upper end of the peripheral wall 11 of the receiving frame 10, and the lock main body 30 rotates about the pivotal support part 37 while the receiving frame abutment part 34 slides on the upper end of the peripheral wall 11 of the receiving frame 10, whereby the cover 20 moves downward. After the hooks 32 pass over the hook receiver 12, the lock main body 30 is held at a posture illustrated in FIG. 1 by the own weight of the lock main body 30 and the torsion spring 41, whereby the cover 20 is locked.

Moreover, coating processing and the like are applied to the lock main body 30 in order to prevent corrosion due to an atmosphere in a sewerage pipe. There is a fear that, in a portion that comes in contact with the receiving frame 10 at the cover closed time, of the lock main body 30, a coating film comes off, a metal surface is exposed, and corrosion progresses from this contact portion. Therefore, with the adoption of a configuration that prevents contact between: portions other than the receiving frame abutment part 34, of the lock main body 30; and the receiving frame 10, for example, the clearance parts 38 that are respectively formed in the side walls 31 as described above, damage and corrosion in portions (for example, the hooks 32) for which the strength is important can be prevented.

Moreover, when the cover 20 is lifted due to a pressure rise in the sewerage pipe, the hooks 32 and the hook receiver 12 engage with each other, and a hinge engagement part (not illustrated) of the cover 20 functions, whereby blow-off of the cover 20 is prevented. The hinge engagement part is attached to the peripheral lower surface of the cover 20 on the side opposite to a portion to which the lock main body 30 is attached. The lifting amount of the cover 20 at this time is determined by a gap in the height direction that exists between the hooks 32 and the hook receiver 12 at the time of locking. In the present embodiment, as has been described above, the fixed hook 52 of the claw 50 is inserted in the gap between the inclined part 24 and the claw abutment surface 36 at the time of opening the cover 20, whereby the elevating amount of the cover 20 at the time of opening can be reduced. Hence, the height of the gap between the hooks 32 and the hook receiver 12 can be reduced.

As described above, suppressing the lifting height of the cover 20 is advantageous in that the cover 20 is less likely to become an obstacle on a road, but is disadvantageous in terms of promptly releasing the pressure in the sewerage pipe. Therefore, in the present embodiment, as described above, the gap 61 is provided between the opening part 25 of the cover 20 and the pressing part 35 of the lock main body 30, whereby the function of releasing the pressure from the gap 61 is provided.

Moreover, when the cover 20 is lifted, three points of: the hooks 32 (two points) of the lock main body 30 and the hinge engagement part (one point, not illustrated) of the cover 20 are supported by the hook receiver 12, and the posture of the cover 20 is kept. Therefore, even when the cover 20 is lifted, the posture of the cover 20 is kept horizontal and stable. Moreover, when the pressure in the sewerage pipe drops and the cover 20 is fitted again in the receiving frame 10, the cover 20 can be smoothly housed in the receiving frame 10 without slanting.

Note that description is given above of the configuration in which the hooks 32 are formed so as to be respectively continuous in plane with the side walls 31, but the hooks 32 may be formed separately from the left and right side walls. Moreover, description is given above of the configuration in which the two hooks 32 engage with the one continuous hook receiver 12, but a plurality of engagement parts may be formed in the hook receiver 12, and one hook 32 that is wide in the circumferential direction may be engaged therewith. Moreover, description is given above of the configuration in which the one receiving frame abutment part 34 is formed inside of the two hooks 32, but a plurality of receiving frame abutment parts 34 may be formed inside of a plurality of hooks 32, and a plurality of receiving frame abutment parts 34 may be formed outside of at least one hook 32. Moreover, description is given above of the communication part 33 that is substantially rectangular in cross-section, but the shape of the communication part 33 is not limited to this, and the communication part 33 may be formed in a wall shape having the same height as the total height of the side walls 31. Modes obtained by adding such changes or improvements can also be encompassed within the technical range of the present invention, which is obvious from the description of Claims.

Reference Signs List

| | |
|---|---|
| 10 | receiving frame |
| 11 | peripheral wall |
| 12 | hook receiver |
| 20 | cover |
| 21 | peripheral wall |
| 22 | recessed part |
| 23 | claw engagement part |
| 24 | inclined part |
| 25 | opening part |
| 30 | lock main body |
| 31 | side wall |
| 32 | hook |
| 33 | communication part |
| 34 | receiving frame abutment part |
| 35 | pressing part |
| 36 | claw abutment surface |
| 37 | pivotal support part |
| 38 | clearance part |
| 41 | torsion spring |
| 50 | claw |
| 51 | rotating hook |
| 52 | fixed hook |
| 53 | claw pivotal support part |
| 54 | protrusion part |
| 61 | gap |

1. A locking apparatus for a manhole iron cover, for locking a cover fitted in a receiving frame, comprising:
a lock main body that is attached to a peripheral lower surface of the cover and includes at least one hook;
a recessed part that is formed on an upper surface of the cover and includes an engagement part that engages with a claw for opening the cover; and
a hook receiver that is formed in a peripheral wall lower part of the receiving frame and engages with the hook, wherein
the lock main body includes: a pivotal support part having an axis that is parallel to a lower surface of the cover; and a pressing part on a peripheral side of the cover with respect to the pivotal support part,
a claw abutment surface that abuts against the claw is formed on an upper surface of the pressing part,
an inclined part is formed on the lower surface of the cover, the lower surface being opposed to the claw abutment surface,
when the hook and the hook receiver engage with each other, the claw abutment surface and an upper surface of the receiving frame are located at substantially a same height, and
the lock main body itself is attached rotatably about the pivotal support part.

2. The locking apparatus for the manhole iron cover according to claim 1, wherein
the lock main body includes at least one receiving frame abutment part below the pivotal support part, the receiving frame abutment part being abuttable against a peripheral wall upper part of the receiving frame, and
a clearance part for avoiding contact with the peripheral wall upper part of the receiving frame is formed in a lower part of the hook.

3. The locking apparatus for the manhole iron cover according to claim 2, wherein the receiving frame abutment part is formed in substantially a center of the lock main body.

4. The locking apparatus for the manhole iron cover according to claim 2, wherein the receiving frame abutment part is formed on each of left and right sides with respect to the center of the lock main body.

5. The locking apparatus for the manhole iron cover according to claim 1, wherein an engagement part between the hook and the hook receiver is provided on each of left and right sides with respect to the center of the lock main body.

6. The locking apparatus for the manhole iron cover according to claim 1, wherein the hook is formed below the pivotal support part and on the peripheral side of the cover with respect to the pivotal support part.

7. The locking apparatus for the manhole iron cover according to claim 1, wherein
a width of an opening part that is formed in a peripheral wall of the cover and is continuous with the inclined part is larger than a width of the pressing part, and
a gap in a circumferential direction of the cover exists between the opening part and the pressing part.
